(19) United States
(12) Patent Application Publication
(10) Pub. No.: US 2020/0291786 A1
(43) Pub. Date: Sep. 17, 2020

(54) AEROFOIL FOR GAS TURBINE INCORPORATING ONE OR MORE ENCAPSULATED VOID

(71) Applicant: Siemens Aktiengesellschaft, Munich (DE)

(72) Inventor: Glynn Milner, Fiskerton, Lincoln (GB)

(73) Assignee: Siemens Aktiengesellschaft, Munich (DE)

(21) Appl. No.: 16/083,987

(22) PCT Filed: Mar. 14, 2017
(86) PCT No.: PCT/EP2017/056023

§ 371 Date: Sep. 11, 2018

(30) Foreign Application Priority Data
Mar. 17, 2016 (GB) 1604525.4

(51) Int. Cl. F01D 5/16

(52) U.S. Cl. CPC F01D 5/16; F05D 2260/96; F05D 2240/30; F05D 2220/32

(57) ABSTRACT

An aerofoil for a gas turbine, wherein the aerofoil extends from a platform and includes a concave and a convex side that meet at a trailing edge and a leading edge. The aerofoil has a tip and one or more voids. Each of the one or more voids is completely encapsulated within the aerofoil such that each of the one or more voids is not fluidly connected with an outside of the aerofoil. Moreover, a total volume of the one or more voids is between 5 percent and 30 percent of a volume of the aerofoil.

### CROSS REFERENCE TO RELATED APPLICATIONS

This application is the US National Stage of International Application No. PCT/EP2017/056023 filed Mar. 14, 2017, and claims the benefit thereof. The International Application claims the benefit of United Kingdom Application No. GB 1604525.4 filed Mar. 17, 2016. All of the applications are incorporated by reference herein in their entirety.

### FIELD OF INVENTION

The present invention relates to gas turbines, and more particularly to aerofoils for a gas turbine.

### BACKGROUND OF INVENTION

When a gas turbine is operated at a given operational stage for example idle stage, take-off stage, climb stage, cruise stage, etc. aerofoils in the compressor section of the gas turbine are subjected to various excitation frequencies depending upon the stage of operation of the gas turbine. Generally, the excitation frequency which the aerofoil is subjected to is related to a rotational speed of the turbine which in turn depends on the operational stage of the turbine. The excitation frequency may also be dependent on other factors such as disturbances in the airflow around the aerofoil.

The aerofoils are capable of vibrating in different vibrational modes for example bending mode, edgewise mode, torsional mode, camber mode, and so on and so forth. The natural frequency for a given vibrational mode of the aerofoil is also sometimes referred to as the vibrational mode frequency for the given vibrational mode of the aerofoil. If the aerofoil experiences an excitation frequency equal to its natural frequency or vibrational mode frequency for a given vibrational mode, the aerofoil, and thus the blade having the aerofoil, is prone to failure as a result of resonant vibrations occurring in the aerofoil. Therefore, it is important to prevent resonant vibration in the aerofoil during operating conditions at a given operational stage.

Thus, in the aerofoil it is desirable to tune certain frequencies, i.e. natural frequency or vibrational mode frequency, out of undesirable ranges, i.e. frequencies around the excitation frequency for a given operational stage, to obviate or to at least reduce possibilities of substantial matching of the vibrational mode frequency and the excitation frequency at the given operational stage of the gas turbine, i.e. to reduce the number of times when the aerofoil will experience an excitation frequency equal to one of its natural frequencies at a given running condition.

### SUMMARY OF INVENTION

Thus an object of the present disclosure is to provide an aerofoil for a gas turbine wherein a mass and stiffness of parts of aerofoil are manipulated such that the natural frequency or vibrational mode frequency for a given vibrational mode of the aerofoil is tuned out of undesirable ranges, i.e. tuned out of the frequencies around the excitation frequency for a given operational stage of the turbine.

The above objects are achieved by an aerofoil, a compressor for a gas turbine, a method for designing an aerofoil for a gas turbine, and a method for manufacturing an aerofoil for a gas turbine according to the present technique. Advantageous embodiments of the present technique are provided in dependent claims. Features of the independent claims may be combined with features of claims dependent on them respectively, and features of dependent claims can be combined together.

In a first aspect of the present technique, an aerofoil for a gas turbine or turbomachine is presented. The aerofoil extends from a platform. The aerofoil includes a generally concave side, also called pressure side, and a generally convex side, also called suction side. The concave side and the convex side meet at a trailing edge on one end and a leading edge on another end. The aerofoil has a tip. Furthermore the aerofoil has one or more voids. Each of the one or more voids is completely encapsulated within the aerofoil such that each of the one or more voids is not fluidly connected with an outside of the aerofoil i.e. no fluid, such as air, gas or a cooling liquid, can flow or flows from the outside of the aerofoil into the voids of the aerofoil. Similarly no fluid such as air, gas or a cooling liquid, can flow or flows from the voids of the aerofoil to the outside of the aerofoil. Moreover, a total volume of the one or more voids i.e. a total volume of all the voids, whether one or multiple, is between 5 percent and 30 percent of a volume of the aerofoil. The volume of the aerofoil is a volume defined by the concave side, the convex side, the leading edge, the trailing edge, the tip and a surface of the platform from which the aerofoil extends radially.

For a given vibrational mode of the aerofoil, a vibrational mode frequency corresponding to the given vibrational mode of the aerofoil is dependent on the mass and stiffness of a flexing section or flexing region of the aerofoil i.e. that region in the aerofoil which is subjected to maximum warping or bending and then reverting to shape in the given vibrational mode. The vibrational mode frequency corresponding to the given vibrational mode of the aerofoil is also dependent on the mass and stiffness of regions in the aerofoil around the flexing region of the aerofoil. Alterations of mass and stiffness of the flexing region or the regions surrounding the flexing region in the aerofoil alter the vibrational mode frequency of the given vibrational mode of the aerofoil. By introducing the one or more voids in the aerofoil in the flexing region or in the regions around the flexing region the mass and the stiffness of the flexing region or the regions around the flexing region in the aerofoil are altered and this in turn alters, i.e. lowers or increases, the vibrational mode frequency for the given vibrational mode.

Thus by having the one or more voids in the aerofoil with respect to the flexing region, i.e. either in the flexing region or outside the flexing region, the vibrational mode frequency is different as compared to a scenario when none of the one or more voids are present in the aerofoil. If in an aerofoil without the one or more voids the vibrational mode frequency would have been same or substantially similar to an excitation frequency to which the aerofoil may be subjected to in the gas turbine operating at a particular stage of operation, then in that aerofoil but now having the one or more voids the vibrational mode frequency differs from the excitation frequency to which the aerofoil may be subjected to in the gas turbine operating at the particular stage of operation. Thus ensuring reduction in possibility of occurrences of the given vibrational mode of the aerofoil when the gas turbine is operated at the particular stage of operation.

In a second aspect of the present technique, a compressor for a gas turbine is presented. The compressor includes an aerofoil as presented according to the first aspect of the present technique.

In a third aspect of the present technique, a method for designing an aerofoil for a gas turbine is presented. The method includes a step of identifying a flexing section in the aerofoil, wherein the flexing section corresponds to a predetermined vibrational mode of the aerofoil and a step of determining a vibrational mode frequency of the aerofoil, wherein the vibrational mode frequency corresponds to the predetermined vibrational mode of the aerofoil. The method further includes a step of determining an external excitation frequency for the aerofoil, wherein the external excitation frequency corresponds to an operational stage of the gas turbine. The method finally includes a step of altering the vibrational mode frequency of the aerofoil by introducing one or more voids in the aerofoil positioned inside the aerofoil with respect to the flexing section such that the vibrational mode frequency of the aerofoil after alteration is distinct from the external excitation frequency. In the method each of the one or more voids is completely encapsulated within the aerofoil such that each of the one or more voids is not fluidly connected with an outside of the aerofoil and wherein a total volume of the one or more voids is between 5 percent and 30 percent of a volume of the aerofoil. By introducing the one or more voids in the aerofoil in the flexing region or in the regions around the flexing region the mass and the stiffness of the flexing region or the regions around the flexing region in the aerofoil are altered and this in turn alters, i.e. lowers or increases, the vibrational mode frequency for the a vibrational mode. Thus the method of designing the aerofoil ensures a reduction in possibility of occurrences of the given vibrational mode of the aerofoil when the gas turbine is operated at the particular stage of operation.

In an embodiment of the method for designing, in the step of altering the vibrational mode frequency the one or more voids are introduced in the flexing section of the aerofoil to lower the vibrational mode frequency. In another embodiment of the method, in the step of altering the vibrational mode frequency the one or more voids are introduced outside of the flexing section of the aerofoil to increase the vibrational mode frequency. In the method the predetermined vibrational mode of the aerofoil is one of a bending mode, a torsional mode, an extension mode, a camber mode and a combination thereof.

In a fourth aspect of the present technique a method of manufacturing an aerofoil for a gas turbine is presented. The method includes a step of designing the aerofoil for the gas turbine according to the third aspect of the present technique and a step of forming the aerofoil according to the aerofoil so designed. In one embodiment of the method the step of forming the aerofoil comprises additive manufacturing technique.

### BRIEF DESCRIPTION OF THE DRAWINGS

The above mentioned attributes and other features and advantages of the present technique and the manner of attaining them will become more apparent and the present technique itself will be better understood by reference to the following description of embodiments of the present technique taken in conjunction with the accompanying drawings, wherein:

FIG. 1 shows part of a turbine engine in a sectional view and in which an aerofoil of the present technique is incorporated;

FIG. 2 schematically illustrates a front view of an exemplary embodiment of an aerofoil with a void in accordance with aspects of the present technique;

FIG. 3 schematically illustrates a cross-section of a side view of the aerofoil with the void of FIG. 2;

FIG. 4 schematically illustrates a cross-section of a top view of the aerofoil with the void of FIGS. 2 and 3;

FIG. 5 schematically illustrates another exemplary embodiment of the aerofoil with multiple voids;

FIG. 6 schematically illustrates another exemplary embodiment of the aerofoil with multiple voids depicting a scheme for determining locations of each of the voids within the aerofoil;

FIG. 7 schematically illustrates an exemplary embodiment of the aerofoil with voids depicting a scheme of locations for the voids;

FIG. 8 schematically illustrates another exemplary embodiment of the aerofoil with voids depicting another scheme of locations for the voids;

FIG. 9 schematically illustrates yet another exemplary embodiment of the aerofoil with voids depicting yet another scheme of locations for the voids;

FIG. 10 schematically illustrates an alternative exemplary embodiment of the aerofoil of FIG. 9 with voids depicting an alternative scheme of locations for the voids as opposed to the scheme of location depicted in FIG. 9;

FIG. 11 schematically illustrates a further exemplary embodiment of the aerofoil with voids depicting further scheme of locations for the voids;

FIG. 12 schematically illustrates an alternative exemplary embodiment of the aerofoil of FIG. 11 with voids depicting an alternative scheme of locations for the voids as opposed to the scheme of location depicted in FIG. 11;

FIG. 13 schematically illustrates one more exemplary embodiment of the aerofoil with voids depicting one more scheme of locations for the voids;

FIG. 14 is a flow chart depicting a method for designing an aerofoil;

FIG. 15 schematically illustrates a model of an exemplary embodiment of the aerofoil for the method for designing the aerofoil;

FIG. 16 schematically illustrates a model of another exemplary embodiment of the aerofoil for the method for designing the aerofoil; and

FIG. 17 is a flow chart depicting a method for manufacturing an aerofoil with voids; in accordance with aspects of the present technique.

### DETAILED DESCRIPTION OF INVENTION

Hereinafter, above-mentioned and other features of the present technique are described in details. Various embodiments are described with reference to the drawing, wherein like reference numerals are used to refer to like elements throughout. In the following description, for purpose of explanation, numerous specific details are set forth in order to provide a thorough understanding of one or more embodiments. It may be noted that the illustrated embodiments are intended to explain, and not to limit the invention. It may be evident that such embodiments may be practiced without these specific details.

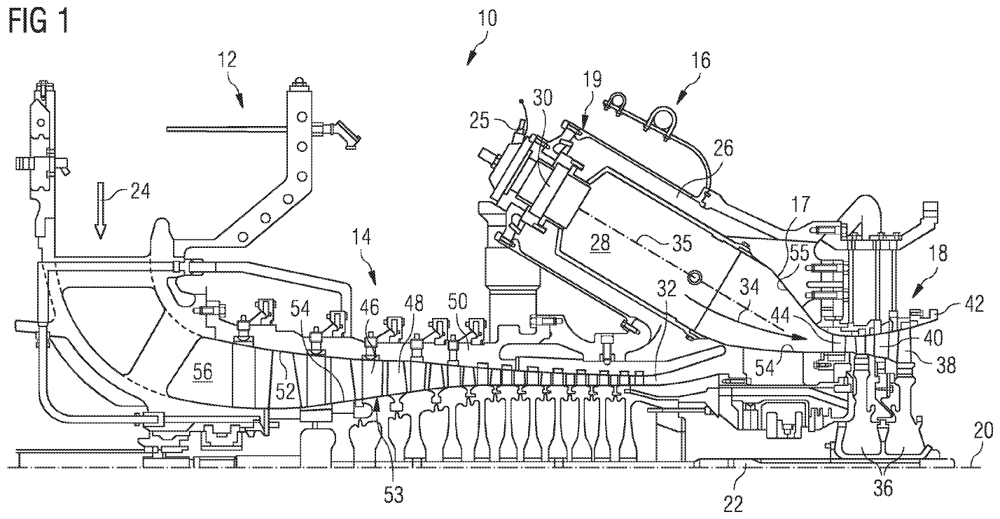

FIG. 1 shows an example of a gas turbine engine 10 in a sectional view. The gas turbine engine 10 comprises, in flow series, an inlet 12, a compressor or compressor section 14, a combustor section 16 and a turbine section 18 which are generally arranged in flow series and generally about and in the direction of a longitudinal or rotational axis 20. The gas turbine engine 10 further comprises a shaft 22 which is rotatable about the rotational axis 20 and which extends longitudinally through the gas turbine engine 10. The shaft 22 drivingly connects the turbine section 18 to the compressor section 14.

In operation of the gas turbine engine 10, air 24, which is taken in through the air inlet 12 is compressed by the compressor section 14 and delivered to the combustion section or burner section 16. The burner section 16 comprises a burner plenum 26, one or more combustion chambers 28 and at least one burner 30 fixed to each combustion chamber 28. The combustion chambers 28 and the burners 30 are located inside the burner plenum 26. The compressed air passing through the compressor 14 enters a diffuser 32 and is discharged from the diffuser 32 into the burner plenum 26 from where a portion of the air enters the burner 30 and is mixed with a gaseous or liquid fuel. The air/fuel mixture is then burned and the combustion gas 34 or working gas from the combustion is channeled through the combustion chamber 28 to the turbine section 18 via a transition duct 17.

This exemplary gas turbine engine 10 has a cannular combustor section arrangement 16, which is constituted by an annular array of combustor cans 19 each having the burner 30 and the combustion chamber 28, the transition duct 17 has a generally circular inlet that interfaces with the combustor chamber 28 and an outlet in the form of an annular segment. An annular array of transition duct outlets form an annulus for channeling the combustion gases to the turbine 18.

The turbine section 18 comprises a number of blade carrying discs 36 attached to the shaft 22. In the present example, two discs 36 each carry an annular array of turbine blades 38. However, the number of blade carrying discs could be different, i.e. only one disc or more than two discs. In addition, guiding vanes 40, which are fixed to a stator 42 of the gas turbine engine 10, are disposed between the stages of annular arrays of turbine blades 38. Between the exit of the combustion chamber 28 and the leading turbine blades 38 inlet guiding vanes 44 are provided and turn the flow of working gas onto the turbine blades 38.

The combustion gas from the combustion chamber 28 enters the turbine section 18 and drives the turbine blades 38 which in turn rotate the shaft 22. The guiding vanes 40, 44 serve to optimise the angle of the combustion or working gas on the turbine blades 38.

The turbine section 18 drives the compressor section 14. The compressor section 14 comprises an axial series of vane stages 46 and rotor blade stages 48. The rotor blade stages 48 comprise a rotor disc supporting an annular array of blades. The compressor section 14 also comprises a casing 50 that surrounds the rotor stages and supports the vane stages 48. The guide vane stages include an annular array of radially extending vanes that are mounted to the casing 50. The vanes are provided to present gas flow at an optimal angle for the blades at a given engine operational point. Some of the guide vane stages have variable vanes, where the angle of the vanes, about their own longitudinal axis, can be adjusted for angle according to air flow characteristics that can occur at different engine operations conditions.

The casing 50 defines a radially outer surface 52 of the passage 56 of the compressor 14. A radially inner surface 54 of the passage 56 is at least partly defined by a rotor drum 53 of the rotor which is partly defined by the annular array of blades 48.

The present technique is described with reference to the above exemplary turbine engine having a single shaft or spool connecting a single, multi-stage compressor and a single, one or more stage turbine. However, it should be appreciated that the present technique is equally applicable to two or three shaft engines and which can be used for industrial, aero or marine applications.

The terms upstream and downstream refer to the flow direction of the airflow and/or working gas flow through the engine unless otherwise stated. The terms forward and rearward refer to the general flow of gas through the engine. The terms axial, radial and circumferential are made with reference to the rotational axis 20 of the engine.

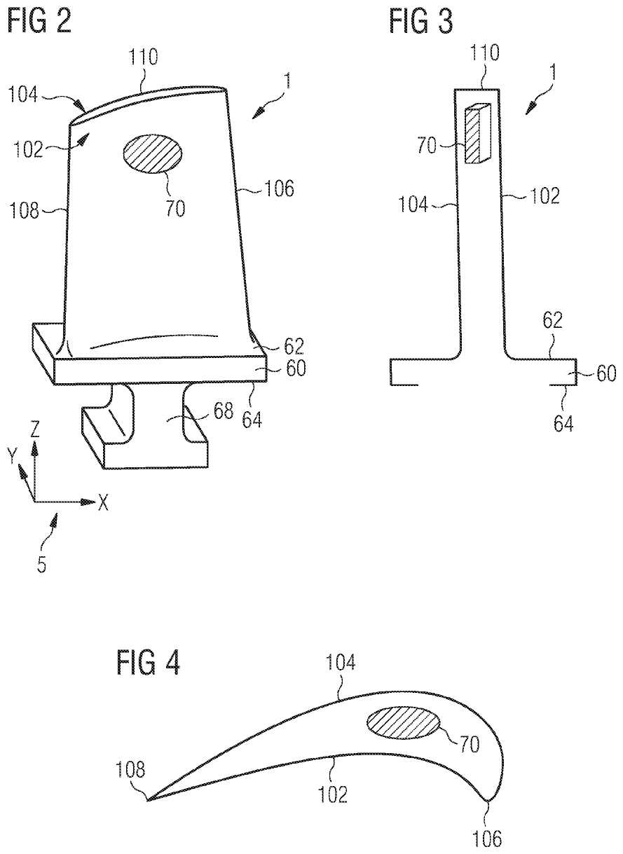

FIGS. 2, 3 and 4 schematically illustrate different views of an exemplary embodiment of an aerofoil 1 with a void 70, in accordance with aspects of the present technique. FIGS. 2-4 have been explained hereinafter in combination with FIG. 1. The aerofoil 1 extends from a platform 60, and more particularly from a side 62, hereinafter referred to as the aerofoil side 62, of the platform 60. From another side 64, hereinafter referred to as the root side 64, of the platform 60 emanates a root 68 or a fixing part 68. The root 68 or the fixing part 68 may be used to attach the aerofoil 1 to a compressor disc (not shown in FIGS. 2-4) and thus the aerofoil 1 forms a part of the compressor blades 48 in the compressor section 14. The present technique may be implemented in the aerofoil 1 having an average chord/thickness aspect ratio typically above 8. The root 68 or the fixing part 68 may alternatively be used to attach the aerofoil 1 to the casing 50 and thus the aerofoil 1 forms a part of the compressor vanes 46 in the compressor section 14.

The aerofoil 1 includes a generally convex side 104, also called suction side 104, and a generally concave side 102, also called pressure side 102. The convex side 104 and the concave side 102 meet at a trailing edge 108 on one end and a leading edge 106 on another end. The aerofoil 1 has a tip 110. The aerofoil 1 may also include a shroud (not shown) at the tip 110 of the aerofoil 1. According to the present technique, furthermore, the aerofoil 1 has one or more voids 70. Each of the one or more voids 70 is completely encapsulated within the aerofoil 1 such that each of the one or more voids 70 is not fluidly connected with an outside 5 of the aerofoil i.e. no fluid, such as air, gas or a cooling liquid, can flow or flows from the outside 5 of the aerofoil 1 into the void 70 of the aerofoil 1. Similarly no fluid such as air, gas or a cooling liquid, can flow or flows from the void 70 of the aerofoil 1 to the outside 5 of the aerofoil. The outside 5 of the aerofoil 1 may be a space directly outside of the aerofoil 1 or may be a pathway (not shown) such as a cooling channel or an opening that is fluidly connected to the outside 5 of the aerofoil 1.

Moreover, a total volume of the one or more voids 70 i.e. a total volume of all the voids 70, whether one or multiple, is between 5 percent and 30 percent of a volume of the aerofoil 1. The volume of the aerofoil 1 is a volume defined by the concave side 102, the convex side 104, the leading edge 106, the trailing edge 108, the tip 110 and the aerofoil side 62 of the platform 60 from which the aerofoil 1 extends radially. The volume of the aerofoil 1 may be understood as the space enclosed by the aerofoil 1 and includes the total volume of all the voids 70, and the volume occupied by material of the aerofoil 1 in forming the aerofoil 1, as well as any other channels or pathways that may be defined within the aerofoil 1. The volume of the aerofoil 1 does not include a volume of the platform 60 and the root 68. The aerofoil 1 may be formed of a homogenous material or may be formed of a composite material.

It may be noted that the void 70 will not be visible from an outside 5 of the aerofoil 1 and the void 70 has been made schematically visible in FIG. 2 only for purposes of explanation. FIG. 2 may be understood as if a part of the concave wall 102 has been removed to show the void 70 which is internal to the convex side 104, the concave side 102, the leading edge 106, the trailing edge 108, the tip 110 and the aerofoil side 62 of the platform 60 and completely limited within the space defined by the convex side 104, the concave side 102, the leading edge 106, the trailing edge 108, the tip 110 and the aerofoil side 62 of the platform 60. Furthermore, the void 70 is physically removed from and does not open at the convex side 104, the concave side 102, the leading edge 106, the trailing edge 108, the tip 110 and the aerofoil side 62 of the platform 60. FIGS. 2 and 3 show a more realistic representation of the void 70 of the aerofoil 1, and as shown in FIGS. 2 and 3, the void 70 is physically removed from external surfaces of the convex side 104, the concave side 102, the leading edge 106, the trailing edge 108, the tip 110 and the aerofoil side 62 of the platform 60. The void 70 has a direct effect on mass and stiffness of a part of the aerofoil 1 where the void 70 is present, for example as depicted in FIG. 2 the void 70 is present towards the middle of the aerofoil 1 and towards the tip 110 of the aerofoil 1 and thus the void 70 decreases the mass and the stiffness of that part of the aerofoil 1 where the void 70 is present, as compared to a respective part in a similar aerofoil (not shown) but without the void 70. Additionally, the void 70 has also an effect on physical property such as mass of another part which is adjacent to the part of the aerofoil 1 where the void 70 is present, for example as depicted in FIG. 2 the a part of the aerofoil 1 between the part of the aerofoil where the void 70 is present and the aerofoil side 62 of the platform 60.

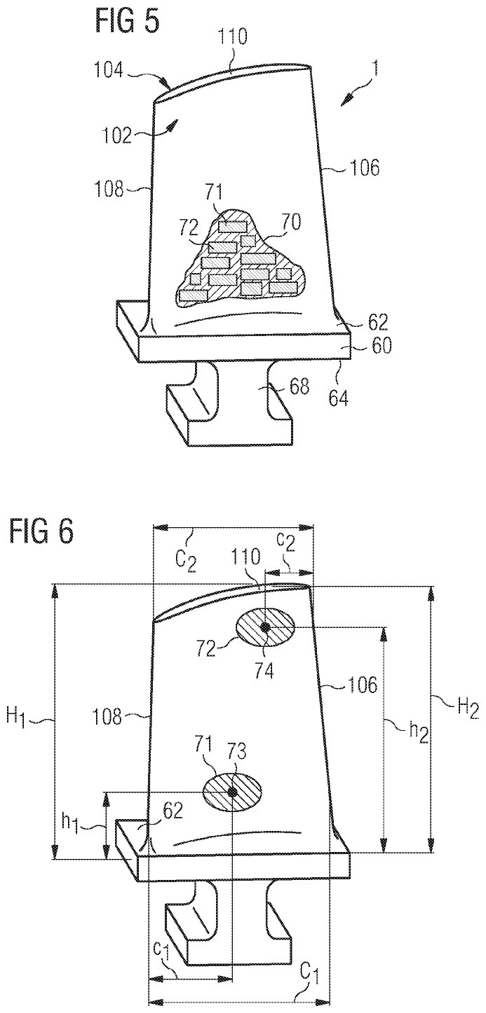

FIG. 5 represents an exemplary embodiment of the aerofoil 1 where the void 70 includes at least a first void 71 and a second void 72, and may include more voids as well. Each of the voids 71, 72 may be positioned in the aerofoil 1 in a part of interest. The total volume of the one or more voids 70 i.e. a total volume of all the voids 71, 72 forming the void 70, is between 5 percent and 30 percent of the volume of the aerofoil 1.

Vibration mode frequencies are a function of the mass and stiffness of the aerofoil 1, particularly of the parts of the aerofoil 1 which undergo maximum flexing in the aerofoil 1. Mass and stiffness are defined by the shape, volume, strength (modulus) and density of the material forming the aerofoil 1.

Introduction of completely encapsulated voids 70 i.e. for example say voids 71, 72, into an otherwise solid metallic aerofoil 1 whilst using no separate parts, joining techniques or additional materials ensures homogeneity and structural integrity of the aerofoil 1. The encapsulated void 70 has no fluid flow through it and by means of the absence of material in the void 70 the mass and stiffness of the part of the aerofoil 1 where the void 70 is located is reduced which in turn can alter the vibrational mode frequency of the aerofoil 1.

The void 70, for example the voids 71, 72 may be selectively shaped, scaled and positioned within the aerofoil 1 so as to beneficially affect the vibrational behaviour of the aerofoil 1 by moving a vibrational mode frequency value to a higher or to a lower value to avoid coincidence with an exciting frequency. If it is desired to avoid a vibrational mode of the aerofoil 1 by lowering the vibrational mode frequency of the aerofoil 1, then the stiffness is reduced in the flexing part, also called as the dynamically strained part, by incorporating the void 70 in the flexing part.

Alternatively, if it is desired to avoid a vibrational mode of the aerofoil 1 by increasing or raising the vibrational mode frequency of the aerofoil 1, then mass of a part or a section outboard or overhanging of the flexing part is reduced by incorporation of the void 70 in the outboard or the overhanging part and thus the influence of the mass of the outboard or overhanging part on the flexing part is reduced and thus the flexing part acts as more stiff and thereby the vibrational mode frequency in increased.

The shape, scale, i.e. the volumetric size, and position of the void 70 may differ according to the vibration mode being addressed. The shape of the void 70, for example the voids 71, 72, may be spherical, cylindrical, horizontal to the platform 60, vertical to the platform 60 or inclined to the platform 60, may be parallel sided or tapered sided, and may be straight edged, curved or defined by a spline (eg when following a contour of the aerofoil 1 surfaces such as a surface of the concave side 102 or a surface of the convex side 104) or may be freeform i.e. irregular geometric shape. As depicted in FIGS. 3 and 4, the void 70 may be positioned at minimum of 10% of the local aerofoil section thickness away from an external surface, such as the surface of the concave side 102 or the convex side 104. Furthermore at least one of the one or more voids 70 may comprise a support member (not shown) connecting a first inner section (not shown) of the aerofoil 1 and the second inner section (not shown) of the aerofoil 1, wherein the first and the second inner sections of the aerofoil 1 are adjacent to the void 70 and wherein the support member is disposed in the void 70. The support member may be understood as a rib or joint or a bar running from one end of the void 70 to another end of the void 70 and formed of the same material as the rest of the aerofoil 1. In one embodiment, the void 70 may have several such support members and may be visualized as a honeycomb structure of the void 70.

FIG. 6 schematically illustrates another exemplary embodiment of the aerofoil 1 with multiple voids 71, 72, namely the first void 71 and the second void 72, and depicts a scheme for determining locations of each of the voids 71, 72 within the aerofoil 1. Each of the voids 70 has a centroid, for example a centroid 73 of the first void 71, a centroid 74 of the second void 72. The scheme uses ‘radial distance’ and ‘circumferential distance’ to define location of the centroid 73, 74 within the aerofoil 1 and thus the location of the voids 71, 72 within the aerofoil 1. The centroid of the void 70, for example centroids 73 or 74 of the voids 71, 72 may be understood as a point that represents a mean position of all the points of the void 70, 71, 72. For a symmetrical 3D shaped void for example a spherical shaped void 70, 71, 72 the centroid 73, 74 will be geometric center of the void 70, 71, 72. The void 70, 71, 72 may have a desired geometric shape such as, but not limited to, a sphere, a parallelepiped, a cone, a cylinder, and so on and so forth.

The radial distance ‘h’ is measured from the aerofoil side 62 of the platform 60 to the centroid of the void 70, for example for the first void 71, the first radial distance h₁ is measured from the aerofoil side 62 of the platform 60 to the centroid 73 of the first void 71 and for the second void 72, the second radial distance h₂ is measured from the aerofoil side 62 of the platform 60 to the centroid 74 of the second void 72. The radial distances are measured substantially perpendicular to the aerofoil side 62 of the platform 60 or to perpendicular to the rotational axis 20. The circumferential distance ‘c’ is measured from the leading edge 106 or the trailing edge 108, as specified with the measurement and is performed substantially perpendicular to the radial direction, i.e. substantially perpendicularly to the platform 60, upto the centroid of the void 70, for example for the first void 71, the first circumferential distance c₁ may be measured from the leading edge 106 or the trailing edge 108, as may be specified with the measurement, to the centroid 73 of the first void 71 and for the second void 72, the second circumferential distance c₂ may be measured from the leading edge 106 or the trailing edge 108, as may be specified with the measurement, to the centroid 74 of the second void 72. The circumferential distances are measured substantially tangential to the rotational axis 20. Thus from the radial distances h₁, h₂ and the circumferential distances c₁, c₂ of the centroid 73, 74 of the first void 71 and/or the second void 72, a location of the first void 71 and/or the second void 72 within the aerofoil 1 is determined.

The radial distance h for a centroid of the void 70 is expressed hereinafter as percentages of a height ‘H’ of the aerofoil 1 measured from the aerofoil side 62 of the platform upto the tip 110 of the aerofoil 1 through the centroid for which the radial distance is being measured. For example, the first radial distance h₁ of the centroid 73 of the first void 71 has been expressed hereinafter as percentage of a height ‘H’ of the aerofoil 1 measured from the aerofoil side 62 of the platform upto the tip 110 of the aerofoil 1 through the centroid 73 of the first void 71. The measurement of the height H in relation to which the first radial distance h₁ is expressed is performed substantially perpendicularly to the aerofoil side 62 of the platform 60, or in other words measurement of the height H in relation to which the first radial distance h₁ is expressed is performed along the first radial distance h₁. Similarly, the second radial distance h₂ of the centroid 74 of the second void 72 has been expressed hereinafter as percentage of a height ‘H’ of the aerofoil 1 measured from the aerofoil side 62 of the platform upto the tip 110 of the aerofoil 1 through the centroid 74 of the second void 72. The measurement of the height H in relation to which the second radial distance h₂ is expressed is performed substantially perpendicularly to the aerofoil side 62 of the platform 60, or in other words measurement of the height H in relation to which the second radial distance h₂ is expressed is performed along the second radial distance h₂.

The circumferential distance c for a centroid of the void 70 is expressed hereinafter as percentages of a chord length ‘C’ of the aerofoil 1 measured from the leading edge 106 to the trailing edge 108 of the aerofoil 1 through the centroid for which the radial distance is being measured. For example, the first circumferential distance c₁ of the centroid 73 of the first void 71 has been expressed hereinafter as percentage of a chord length ‘C’ of the aerofoil 1 measured from the leading edge 106 to the trailing edge 108 of the aerofoil 1 through the centroid 73 of the first void 71. The measurement of the chord length C in relation to which the first circumferential distance c₁ is expressed is performed substantially parallelly to the aerofoil side 62 of the platform 60, or in other words measurement of the chord length C in relation to which the first circumferential distance c₁ is expressed is performed along the circumferential distance c₁. Similarly, the second circumferential distance c₂ of the centroid 74 of the second void 72 has been expressed hereinafter as percentage of a chord length ‘C’ of the aerofoil 1 measured from the leading edge 106 to the trailing edge 108 of the aerofoil 1 through the centroid 74 of the second void 72. The measurement of the chord length C in relation to which the second circumferential distance c₂ is expressed is performed substantially parallelly to the aerofoil side 62 of the platform 60, or in other words measurement of the chord length C in relation to which the second circumferential distance c₂ is expressed is performed along the second circumferential distance c₂.

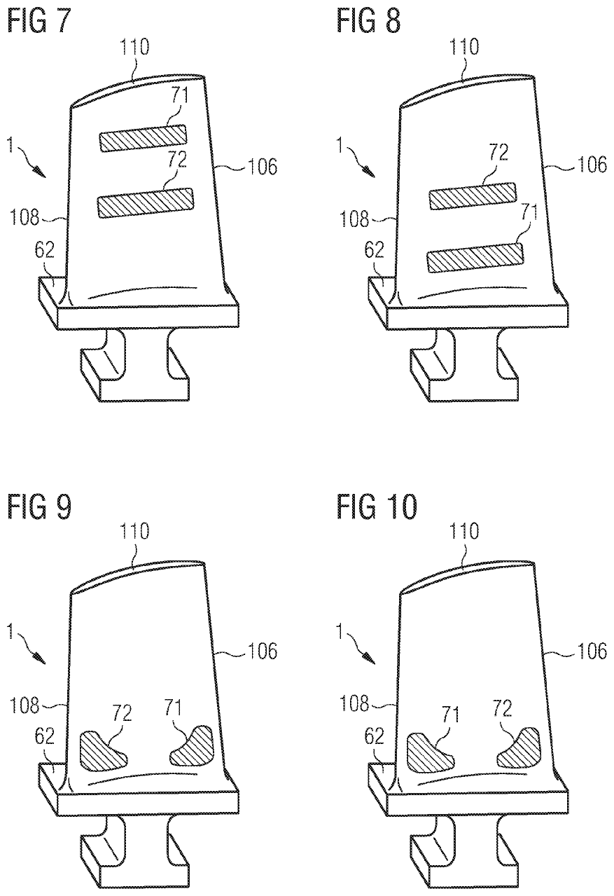

FIGS. 7 to 13 present various exemplary embodiments of the aerofoil 1 of the present technique depicting different locations for the first void 71 and/or the second void 72 enclosed within the aerofoil 1. It may be noted that the location of the first void 71 has been expressed by defining the first radial distance h₁ and the first circumferential distance c₁ of the centroid 73 of the first void 71, although the centroid 73 has not been depicted in FIGS. 7 to 13 for sake of simplicity. Similarly, the location of the second void 72, if present, has been expressed by defining the second radial distance h₂ and the second circumferential distance c₂ of the centroid 74 of the second void 72, although the centroid 74 has not been depicted in FIGS. 7 to 13 for sake of simplicity.

As shown in FIG. 7, the one or more voids 70 includes at least the first void 71 having the centroid 73 positioned at the first radial distance h₁ and the first circumferential distance c₁ measured from the leading edge 106. The first radial distance h₁ of the centroid 73 of the first void 71 is between 60 percent and 90 percent of the height H of the aerofoil 1 measured along the first radial distance h₁ of the centroid 73 of the first void 71 and the first circumferential distance c₁ of the centroid 73 of the first void 71 is between 30 percent and 70 percent of the chord length C of the aerofoil 1 measured along the first circumferential distance c₁ of the centroid 73 of the first void 71.

In vibrational mode 1F i.e. first bending mode or first flapping mode, bending or vibrating of the aerofoil may be visualized to be along YZ plane in a three-coordinate system depicted in FIG. 2, where the X axis is in the direction running on the aerofoil side 62 of the platform 60 along the leading edge 106 and the trailing edge 108, the Y axis is in the direction running on the aerofoil side 62 of the platform 60 and perpendicular to the X axis, and Z axis is mutually perpendicular to both X axis and Y axis. For the 1F mode the dynamic stress or the strain in the aerofoil 1 is centered in the aerofoil 1 just above the aerofoil side 62 of the platform 60. Thus by introducing the first void 71 as shown in FIG. 7, a mass of the overhanging or overboard region of the aerofoil 1 outside the flexing region, i.e. the region in the aerofoil 1 just above the aerofoil side 62 of the platform 60, is decreased and this in turn results in increase of the vibrational mode frequency, corresponding to the 1F mode, of the aerofoil 1.

In vibrational mode 1E i.e. first edgewise mode, bending or vibrating of the aerofoil may be visualized to be along XZ plane in a three-coordinate system depicted in FIG. 2, as explained earlier. For the 1E mode the dynamic stress or the strain in the aerofoil 1 is present in the aerofoil 1 just above the aerofoil side 62 of the platform 60 leaning towards the leading edge 106 and the trailing edge 108, say the flexing section. Thus by introducing the first void 71 as shown in FIG. 7, a mass of the overhanging or overboard region of the aerofoil 1 outside the flexing section is decreased and this in turn results in increase of the vibrational mode frequency, corresponding to the 1E mode, of the aerofoil 1.

Furthermore, the aerofoil 1 may include the second void 72 in addition to the first void 71. The second void 72 having the centroid 74 is positioned at the second radial distance h₂ and the second circumferential distance c₂ measured from the leading edge 106. The second radial distance h₂ of the centroid 74 of the second void 72 is between 40 percent and 60 percent of the height H of the aerofoil 1 measured along the second radial distance h₂ of the centroid 74 of the second void 72 and the second circumferential distance c₂ of the centroid 74 of the second void 72 is between 30 percent and 70 percent of the chord length C of the aerofoil 1 measured along the second circumferential distance c₂ of the centroid 74 of the second void 72. The introduction of the second void 72 aids in decrease in the vibrational mode frequency for 2F mode of vibration, i.e. second order bending mode vibration.

As shown in FIG. 8, the one or more voids 70 includes at least the first void 71 having the centroid 73 positioned at the first radial distance h₁ and the first circumferential distance c₁ measured from the leading edge 106. The first radial distance h₁ of the centroid 73 of the first void 71 is between 5 percent and 20 percent of the height H of the aerofoil 1 measured along the first radial distance h₁ of the centroid 73 of the first void 71 and the first circumferential distance c₁ of the centroid 73 of the first void 71 is between 30 percent and 70 percent of the chord length C of the aerofoil 1 measured along the first circumferential distance c₁ of the centroid 73 of the first void 71.

In vibrational mode 1F i.e. first bending mode or first flapping mode, bending or vibrating of the aerofoil may be visualized to be along YZ plane in the three-coordinate system depicted in FIG. 2. As mentioned earlier, for the 1F mode the dynamic stress or the strain in the aerofoil 1 is centered in the aerofoil 1 just above the aerofoil side 62 of the platform 60, say the flexing section. Thus by introducing the first void 71 as shown in FIG. 8, a mass and stiffness of the flexing section of the aerofoil 1 is decreased and this in turn results in decrease of the vibrational mode frequency, corresponding to the 1F mode, of the aerofoil 1.

Furthermore, as shown in FIG. 8, the aerofoil 1 may include the second void 72 in addition to the first void 71. The second void 72 having the centroid 74 is positioned at the second radial distance h₂ and the second circumferential distance c₂ measured from the leading edge 106. The second radial distance h₂ of the centroid 74 of the second void 72 is between 40 percent and 60 percent of the height H of the aerofoil 1 measured along the second radial distance h₂ of the centroid 74 of the second void 72 and the second circumferential distance c₂ of the centroid 74 of the second void 72 is between 30 percent and 70 percent of the chord length C of the aerofoil 1 measured along the second circumferential distance c₂ of the centroid 74 of the second void 72. The introduction of the second void 72 aids in decrease in the vibrational mode frequency for 2F mode of vibration, i.e. second order bending mode vibration.

As shown in FIGS. 9 and 10, the one or more voids 70 includes at least the first void 71 having the centroid 73 positioned at the first radial distance h₁ and the first circumferential distance c₁ measured from the leading edge 106. The first radial distance h₁ of the centroid 73 of the first void 71 is between 5 percent and 20 percent of the height H of the aerofoil 1 measured along the first radial distance h₁ of the centroid 73 of the first void 71 and the first circumferential distance c₁ of the centroid 73 of the first void 71 is between 10 percent and 25 percent of the chord length C of the aerofoil 1 measured along the first circumferential distance c₁ of the centroid 73 of the first void 71 as depicted in the exemplary embodiment of the aerofoil 1 of FIG. 9, or alternatively, the first circumferential distance c₁ of the centroid 73 of the first void 71 is between 75 percent and 90 percent of the chord length C of the aerofoil 1 measured along the first circumferential distance c₁ of the centroid 73 of the first void 71 as depicted in the exemplary embodiment of the aerofoil 1 of FIG. 10.

Furthermore, as shown in FIGS. 9 and 10, the aerofoil 1 may include the second void 72 in addition to the first void 71. The second void 72 has the centroid 74 positioned at the second radial distance h₂ and the second circumferential distance c₂ measured from the leading edge 106. The second radial distance h₂ of the centroid 74 of the second void 72 is between 5 percent and 20 percent of the height H of the aerofoil 1 measured along the second radial distance h₂ of the centroid 74 of the second void 72 and the second circumferential distance c₂ of the centroid 74 of the second void 72 is between 75 percent and 90 percent of the chord length C of the aerofoil 1 measured along the second circumferential distance c₂ of the centroid 74 of the second void 72 as depicted in the exemplary embodiment of the aerofoil 1 of FIG. 9, or alternatively, the second circumferential distance c₂ of the centroid 74 of the second void 72 is between 10 percent and 25 percent of the chord length C of the aerofoil 1 measured along the second circumferential distance c₂ of the centroid 74 of the second void 72 as depicted in the exemplary embodiment of the aerofoil 1 of FIG. 10.

It may be noted that the circumferential distances c₁ and c₂ described in the present disclosure, for example as described above in relation to FIGS. 9 and 10, have been expressed as measured from the leading edge 106 or the trailing edge, for example for FIGS. 9 and 10 have been expressed as measured from the leading edge 106 but as may be appreciated by one skilled in the art, the circumferential distances c₁ and c₂ can also be expressed as measured from the other edge for example the trailing edge 108 for FIGS. 9 and 10, such as 75 percent to 90 percent from leading edge 106 may be expressed as 10 percent to 25 percent from the trailing edge 108.

In vibrational mode 1E i.e. first edgewise mode, as explained earlier, the dynamic stress or the strain in the aerofoil 1 is present in the aerofoil 1 just above the aerofoil side 62 of the platform 60 leaning towards the leading edge 106 and the trailing edge 108, say the flexing section. Thus by introducing the first void 71, and optionally the second void 72, as shown in FIGS. 9 and 10, a mass and stiffness of the flexing section is decreased and this in turn results in decrease of the vibrational mode frequency, corresponding to the 1E mode, of the aerofoil 1.

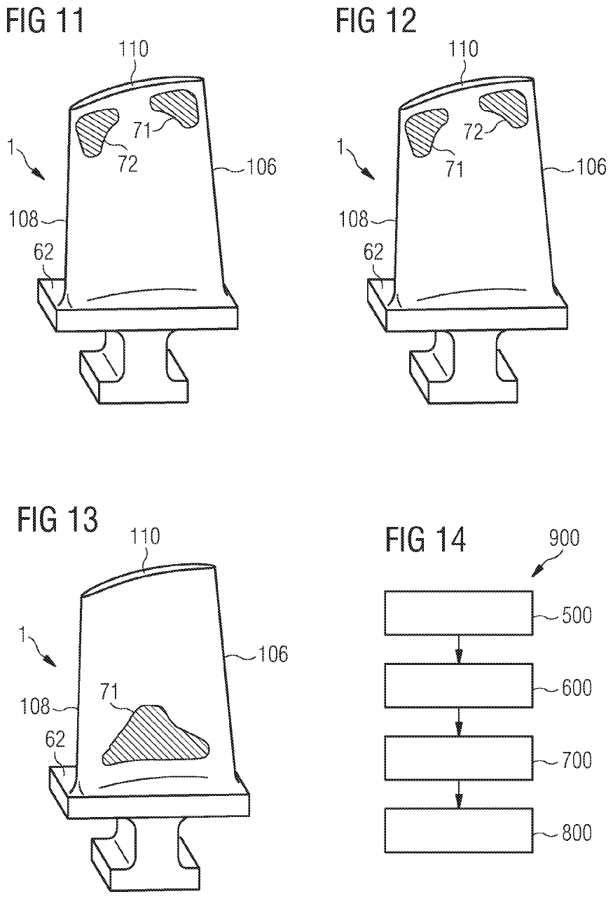

As shown in FIGS. 11 and 12, the one or more voids 70 includes at least the first void 71 having the centroid 73 positioned at the first radial distance h₁ and the first circumferential distance c₁ measured from the leading edge 106. The first radial distance h₁ of the centroid 73 of the first void 71 is between 80 percent and 90 percent of the height H of the aerofoil 1 measured along the first radial distance h₁ of the centroid 73 of the first void 71 and the first circumferential distance c₁ of the centroid 73 of the first void 71 is between 10 percent and 25 percent of the chord length C of the aerofoil 1 measured along the first circumferential distance c₁ of the centroid 73 of the first void 71 as depicted in the exemplary embodiment of the aerofoil 1 of FIG. 11, or alternatively, the first circumferential distance c₁ of the centroid 73 of the first void 71 is between 75 percent and 90 percent of the chord length C of the aerofoil 1 measured along the first circumferential distance c₁ of the centroid 73 of the first void 71 as depicted in the exemplary embodiment of the aerofoil 1 of FIG. 12.

Furthermore, as shown in FIGS. 11 and 12, the aerofoil 1 may include the second void 72 in addition to the first void 71. The second void 72 has the centroid 74 positioned at the second radial distance h₂ and the second circumferential distance c₂ measured from the leading edge 106. The second radial distance h₂ of the centroid 74 of the second void 72 is between 80 percent and 90 percent of the height H of the aerofoil 1 measured along the second radial distance h₂ of the centroid 74 of the second void 72 and the second circumferential distance c₂ of the centroid 74 of the second void 72 is between 75 percent and 90 percent of the chord length C of the aerofoil 1 measured along the second circumferential distance c₂ of the centroid 74 of the second void 72 as depicted in the exemplary embodiment of the aerofoil 1 of FIG. 11, or alternatively, the second circumferential distance c₂ of the centroid 74 of the second void 72 is between 10 percent and 25 percent of the chord length C of the aerofoil 1 measured along the second circumferential distance c₂ of the centroid 74 of the second void 72 as depicted in the exemplary embodiment of the aerofoil 1 of FIG. 12.

In vibrational mode 1T i.e. first torsional mode, bending or vibrating of the aerofoil 1 may be visualized as the aerofoil 1 is fixed at the platform 60 but progressively twists towards the tip 110 as viewed in the XY plane in the three-coordinate system depicted in FIG. 2. For the 1T mode the dynamic stress or the strain in the aerofoil 1 is centered in the aerofoil 1 just above the aerofoil side 62 of the platform 60 centered between the leading edge 106 and the trailing edge 108, say the flexing section. Thus by introducing the first void 71, and optionally the second void 72, as shown in FIGS. 11 and 12, a mass of a region outside the flexing section of the aerofoil 1 is decreased and this in turn results in increase of the vibrational mode frequency, corresponding to the 1T mode, of the aerofoil 1.

As shown in FIG. 13, the one or more voids 70 includes at least the first void 71 having the centroid 73 positioned at the first radial distance h₁ and the first circumferential distance c₁ measured from the leading edge 106. The first radial distance h₁ of the centroid 73 of the first void 71 is between 15 percent and 40 percent of the height H of the aerofoil 1 measured along the first radial distance h₁ of the centroid 73 of the first void 71 and the first circumferential distance c₁ of the centroid 73 of the first void 71 is between 40 percent and 60 percent of the chord length C of the aerofoil 1 measured along the first circumferential distance c₁ of the centroid 73 of the first void 71.

In vibrational mode 1T i.e. first torsional mode, the flexing section in the aerofoil 1 is in the aerofoil 1 just above the aerofoil side 62 of the platform 60 centered between the leading edge 106 and the trailing edge 108. Thus by introducing the first void 71, as shown in FIG. 13, a mass and stiffness of the flexing section of the aerofoil 1 is decreased and this in turn results in decrease of the vibrational mode frequency, corresponding to the 1T mode, of the aerofoil 1.

It may be noted that the vibrational modes addressed in FIGS. 7 to 13 are for exemplary purposes only, and other vibrational modes for example, camber mode or second order vibrational modes, or combination of different vibration modes can be addressed in similar way within the scope of the present technique.

According to the second aspect of the present technique, the aerofoil 1 of the present technique as described in relation to FIGS. 2 to 13 is incorporated in the compressor 14 as shown in FIG. 1.

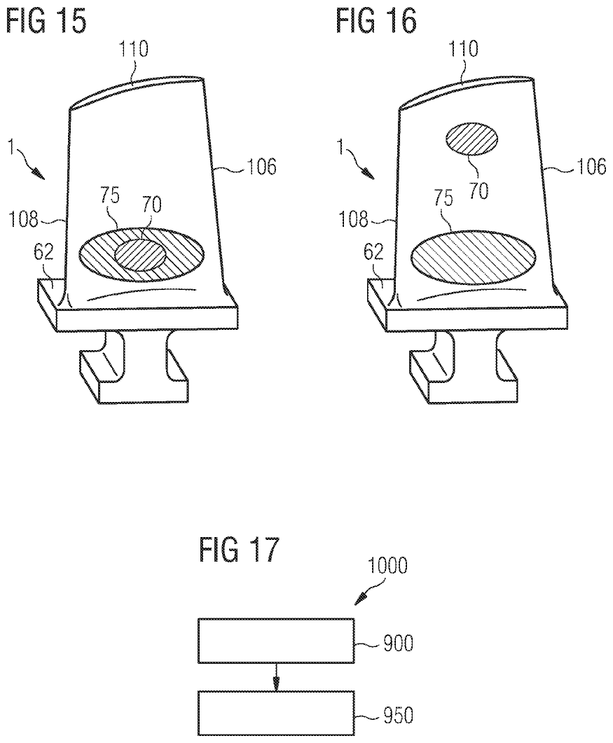

FIG. 14 is a flow chart depicting a method 900 for designing the aerofoil 1. FIGS. 15 and 16 schematically illustrates a model of an exemplary embodiment of the aerofoil 1 for the method 900 for designing the aerofoil 1.

The method 900 includes a step 500 of identifying a flexing section 75 (shown in FIGS. 15 and 16) in the aerofoil 1. The flexing section 75 corresponds to a predetermined vibrational mode of the aerofoil 1. The flexing section 75 in the aerofoil 1 is the section or region in the aerofoil 1 which is subjected to maximum warping or bending and then reverting to shape in the given vibrational mode. The method 900 also includes a step 600 of determining a vibrational mode frequency of the aerofoil 1. The vibrational mode frequency corresponds to the predetermined vibrational mode of the aerofoil 1. The predetermined vibrational mode of the aerofoil 1 may be, but not limited to, one of a bending mode, a torsional mode, an extension mode, a camber mode and a combination thereof.

The method 900 further includes a step 700 of determining an external excitation frequency for the aerofoil 1. The external excitation frequency corresponds to an operational stage of the gas turbine 10. The method 900 finally includes a step 800 of altering the vibrational mode frequency of the aerofoil 1 by introducing one or more voids 70, 71, 72 in the aerofoil 1 positioned inside the aerofoil 1 with respect to the flexing section 75 such that the vibrational mode frequency of the aerofoil 1 after alteration is distinct from the external excitation frequency.

In the method 900 each of the one or more voids 70, 71, 72 is completely encapsulated within the aerofoil 1 and may be understood as explained with reference to FIGS. 2 to 13 hereinabove. Thus each of the one or more voids 70, 71, 72 is not fluidly connected with the outside 5 of the aerofoil 1 and the total volume of the one or more voids 70, 71, 72 is between 5 percent and 30 percent of the volume of the aerofoil 1.

As shown in FIG. 15, in an embodiment of the method 900 for designing the aerofoil 1, in the step 800 the one or more voids 70, 71, 72 are introduced in the flexing section 75 of the aerofoil 1 to lower the vibrational mode frequency. In another embodiment of the method 900, as shown in FIG. 16, in an embodiment of the method 900 for designing the aerofoil 1, in the step 800 the one or more voids 70, 71, 72 are introduced outside the flexing section 75 of the aerofoil 1 to increase or raise the vibrational mode frequency.

FIG. 17 is a flow chart depicting a method 1000 for manufacturing the aerofoil 1 with voids 70, 71, 72; in accordance with aspects of the present technique. The method 1000 includes a step 900 of designing the aerofoil 1 for the gas turbine 10. The step 900 is same as the method 900 explained in reference to FIG. 14 hereinabove. The method 1000 further includes a step 950 of forming the aerofoil 1 according to the aerofoil 1 so designed in the step 900. In one embodiment of the method 1000 the step 950 of forming the aerofoil 1 includes additive manufacturing technique such as, but not limited to, laser sintering, selective laser sintering, and so on and so forth.

While the present technique has been described in detail with reference to certain embodiments, it should be appreciated that the present technique is not limited to those precise embodiments. Rather, in view of the present disclosure which describes exemplary modes for practicing the invention, many modifications and variations would present themselves, to those skilled in the art without departing from the scope and spirit of this invention. The scope of the invention is, therefore, indicated by the following claims rather than by the foregoing description. All changes, modifications, and variations coming within the meaning and range of equivalency of the claims are to be considered within their scope.

### LIST OF REFERENCE CHARACTERS

1 aerofoil
5 outside of the aerofoil
10 gas turbine engine
12 inlet
14 compressor section
16 combustor section or burner section
17 transition duct
18 turbine section
19 combustor cans
20 longitudinal or rotational axis
22 shaft
24 air
26 burner plenum
28 combustion chamber
30 burner
32 diffuser
34 combustion gas or working gas
36 blade carrying discs
38 turbine blades
40 guiding vanes
42 stator
44 inlet guiding vanes
46 vane stages
48 rotor blade stages
50 casing
52 radially outer surface
53 rotor drum
54 radially inner surface
56 passage
60 platform
62 aerofoil side of platoform
64 root side of platform
68 root
70 void
71 first void
72 second void
73 centroid of the first void
74 centroid of the second void
75 flexing section
102 concave side
104 convex side
106 leading edge
108 trailing edge
110 tip
500 step of identifying a flexing section in the aerofoil
600 step of determining a vibrational mode frequency
700 step of determining an external excitation frequency
800 step of altering the vibrational mode frequency
900 method for designing the aerofoil
950 step of forming the aerofoil
1000 method for manufacturing the aerofoil
c₁ circumferential distance of the centroid of first void
c₂ circumferential distance of the centroid of second void
C1, C2 Chord lengths of the aerofoil
h₁ radial distance of the centroid of the first void
h₂ radial distance of the centroid of the second void
H1, H2 Height of the aerofoil

1. An aerofoil for a gas turbine, the aerofoil extending from a platform and comprising:
a convex side and a concave side meeting at a trailing edge and a leading edge,
a tip, and
one or more voids,
wherein each of the one or more voids is completely encapsulated within the aerofoil such that each of the one or more voids is not fluidly connected with an outside of the aerofoil and wherein a total volume of the one or more voids is between 5 percent and 30 percent of a volume of the aerofoil.

2. The aerofoil according to claim 1,
wherein the one or more voids comprises at least a first void having a centroid positioned at a first radial distance and a first circumferential distance, the first radial distance measured from the platform and the first circumferential distance measured from the leading edge, and
wherein the first radial distance of the centroid of the first void is between 60 percent and 90 percent of a height of the aerofoil measured along the first radial distance of the centroid of the first void and the first circumferential distance of the centroid of the first void is between 30 percent and 70 percent of a chord length of the aerofoil measured along the first circumferential distance of the centroid of the first void.

3. The aerofoil according to claim 1,
wherein the one or more voids comprises at least a first void having a centroid positioned at a first radial distance and a first circumferential distance, the first radial distance measured from the platform and the first circumferential distance measured from the leading edge, and
wherein the first radial distance of the centroid of the first void is between 5 percent and 20 percent of a height of the aerofoil measured along the first radial distance of the centroid of the first void and the first circumferential distance of the centroid of the first void is between 30 percent and 70 percent of a chord length of the aerofoil measured along the first circumferential distance of the centroid of the first void.

4. The aerofoil according to claim 2,
wherein the one or more voids comprises at least a second void having a centroid positioned at a second radial distance and a second circumferential distance, the second radial distance measured from the platform and the second circumferential distance measured from the leading edge, and
wherein the second radial distance of the centroid of the second void is between 40 percent and 60 percent of a height of the aerofoil measured along the second radial distance of the centroid of the second void and the second circumferential distance of the centroid of the second void is between 30 percent and 70 percent of a chord length of the aerofoil measured along the second circumferential distance of the centroid of the second void.

5. The aerofoil according to claim 1,
wherein the one or more voids comprises at least a first void having a centroid positioned at a first radial distance and a first circumferential distance, the first radial distance measured from the platform and the first circumferential distance measured from the leading edge or the trailing edge, and
wherein the first radial distance of the centroid of the first void is between 5 percent and 20 percent of a height of the aerofoil measured along the first radial distance of the centroid of the first void and the first circumferential distance of the centroid of the first void is between 10 percent and 25 percent of a chord length of the aerofoil measured along the first circumferential distance of the centroid of the first void.

6. The aerofoil according to claim 5,
wherein the one or more voids comprises at least a second void having a centroid positioned at a second radial distance and a second circumferential distance, the second radial distance measured from the platform and the second circumferential distance measured from the leading edge or the trailing edge, and
wherein the second radial distance of the centroid of the second void is between 5 percent and 20 percent of a height of the aerofoil measured along the second radial distance of the centroid of the second void and the second circumferential distance of the centroid of the second void is between 75 percent and 90 percent of a chord length of the aerofoil measured along the second circumferential distance of the centroid of the second void, and
wherein the first void and the second void are positioned at different edges selected from the leading edge and the trailing edge.

7. The aerofoil according to claim 1,
wherein the one or more voids comprises at least a first void having a centroid positioned at a first radial distance and a first circumferential distance, the first radial distance measured from the platform and the first circumferential distance measured from the leading edge or the trailing edge, and
wherein the first radial distance of the centroid of the first void is between 80 percent and 90 percent of a height of the aerofoil measured along the first radial distance of the centroid of the first void and the first circumferential distance of the centroid of the first void is between 10 percent and 25 percent of a chord length of the aerofoil measured along the first circumferential distance of the centroid of the first void.

8. The aerofoil according to claim 7,
wherein the one or more voids comprises at least a second void having a centroid positioned at a second radial distance and a second circumferential distance, the second radial distance measured from the platform and the second circumferential distance measured from the leading edge or the trailing edge, and
wherein the second radial distance of the centroid of the second void is between 80 percent and 90 percent of a height of the aerofoil measured along the second radial distance of the centroid of the second void and the second circumferential distance of the centroid of the second void is between 75 percent and 90 percent of a chord length of the aerofoil measured along the second circumferential distance of the centroid of the second void, and
wherein the first void and the second void are positioned at different edges selected from the leading edge and the trailing edge.

9. The aerofoil according to claim 1,
wherein the one or more voids comprises at least a first void having a centroid positioned at a first radial distance and a first circumferential distance, the first radial distance measured from the platform and the first circumferential distance measured from the leading edge, and
wherein the first radial distance of the centroid of the first void is between 15 percent and 40 percent of a height of the aerofoil measured along the first radial distance of the centroid of the first void and the first circumferential distance of the first void is between 40 percent and 60 percent of a chord length of the aerofoil measured along the first circumferential distance of the centroid of the first void.

10. A compressor for a gas turbine, wherein the compressor comprises
an aerofoil according to claim 1.

11. A method of designing an aerofoil for a gas turbine, the method comprising:
identifying a flexing section in the aerofoil, wherein the flexing section corresponds to a predetermined vibrational mode of the aerofoil;
determining a vibrational mode frequency of the aerofoil, wherein the vibrational mode frequency corresponds to the predetermined vibrational mode of the aerofoil;
determining an external excitation frequency for the aerofoil, wherein the external excitation frequency corresponds to an operational stage of the gas turbine; and
altering the vibrational mode frequency of the aerofoil by introducing one or more voids in the aerofoil positioned inside the aerofoil with respect to the flexing section such that the vibrational mode frequency of the aerofoil after alteration is distinct from the external excitation frequency,
wherein each of the one or more voids is completely encapsulated within the aerofoil such that each of the one or more voids is not fluidly connected with an outside of the aerofoil and wherein a total volume of the one or more voids is between 5 percent and 30 percent of a volume of the aerofoil.

12. The method according to claim 11,
wherein altering the vibrational mode frequency comprises introducing the one or more voids in the flexing section to lower the vibrational mode frequency.

13. The method according to claim 11,
wherein altering the vibrational mode frequency comprises introducing the one or more voids outside of the flexing section of the aerofoil to increase the vibrational mode frequency.

14. The method according to claim 11,
wherein the predetermined vibrational mode of the aerofoil is one of a bending mode, a torsional mode, an extension mode, a camber mode, and a combination thereof.

15. The method according to claim 11,
wherein altering the vibrational mode frequency comprises introducing a first void of the one or more voids in the aerofoil, the first void having a centroid positioned at a first radial distance and a first circumferential distance, the first radial distance measured from the platform and the first circumferential distance measured from the leading edge, and
wherein the first radial distance of the centroid of the first void is between 60 percent and 90 percent of a height of the aerofoil measured along the first radial distance of the centroid of the first void and the first circumferential distance of the centroid of the first void is between 30 percent and 70 percent of a chord length of the aerofoil measured along the first circumferential distance of the centroid of the first void.

16. The method according to claim 11,
wherein altering the vibrational mode frequency comprises introducing a first void of the one or more voids in the aerofoil, the first void having a centroid positioned at a first radial distance and a first circumferential distance, the first radial distance measured from the platform and the first circumferential distance measured from the leading edge, and
wherein the first radial distance of the centroid of the first void is between 5 percent and 20 percent of a height of the aerofoil measured along the first radial distance of the centroid of the first void and the first circumferential distance of the centroid of the first void is between 30 percent and 70 percent of a chord length of the aerofoil measured along the first circumferential distance of the centroid of the first void.

17. The method according to claim 15,
wherein altering the vibrational mode frequency comprises introducing a second void of the one or more voids in the aerofoil, the second void having a centroid positioned at a second radial distance and a second circumferential distance, the second radial distance measured from the platform and the second circumferential distance measured from the leading edge, and wherein the second radial distance of the centroid of the second void is between 40 percent and 60 percent of a height of the aerofoil measured along the second radial distance of the centroid of the second void and the second circumferential distance of the centroid of the second void is between 30 percent and 70 percent of a chord length of the aerofoil measured along the second circumferential distance of the centroid of the second void.

18. The method according to claim 11,
wherein altering the vibrational mode frequency comprises introducing a first void of the one or more voids in the aerofoil, the first void having a centroid positioned at a first radial distance and a first circumferential distance, the first radial distance measured from the platform and the first circumferential distance measured from the leading edge or the trailing edge, and
wherein the first radial distance of the centroid of the first void is between 5 percent and 20 percent of a height of the aerofoil measured along the first radial distance of the centroid of the first void and the first circumferential distance of the centroid of the first void is between 10 percent and 25 percent of a chord length of the aerofoil measured along the first circumferential distance of the centroid of the first void.

19. The method according to claim 18,
wherein altering the vibrational mode frequency comprises introducing a second void of the one or more voids in the aerofoil, the second void having a centroid positioned at a second radial distance and a second circumferential distance, the second radial distance measured from the platform and the second circumferential distance measured from the leading edge or the trailing edge, and
wherein the second radial distance of the centroid of the second void is between 5 percent and 20 percent of a height of the aerofoil measured along the second radial distance of the centroid of the second void and the second circumferential distance of the centroid of the second void is between 75 percent and 90 percent of a chord length of the aerofoil measured along the second circumferential distance of the centroid of the second void, and
wherein the first void and the second void are positioned at different edges selected from the leading edge and the trailing edge.

20. The method according to claim 11,
wherein altering the vibrational mode frequency comprises introducing a first void of the one or more voids in the aerofoil, the first having a centroid positioned at a first radial distance and a first circumferential distance, the first radial distance measured from the platform and the first circumferential distance measured from the leading edge or the trailing edge, and
wherein the first radial distance of the centroid of the first void is between 80 percent and 90 percent of a height of the aerofoil measured along the first radial distance of the centroid of the first void and the first circumferential distance of the centroid of the first void is between 10 percent and 25 percent of a chord length of the aerofoil measured along the first circumferential distance of the centroid of the first void.

21. The method according to claim 20,
wherein altering the vibrational mode frequency comprises introducing a second void of the one or more voids in the aerofoil, the second void having a centroid positioned at a second radial distance and a second circumferential distance, the second radial distance measured from the platform and the second circumferential distance measured from the leading edge or the trailing edge, and
wherein the second radial distance of the centroid of the second void is between 80 percent and 90 percent of a height of the aerofoil measured along the second radial distance of the centroid of the second void and the second circumferential distance of the centroid of the second void is between 75 percent and 90 percent of a chord length of the aerofoil measured along the second circumferential distance of the centroid of the second void, and
wherein the first void and the second void are positioned at different edges selected from the leading edge and the trailing edge.

22. The method according to claim 11,
wherein altering the vibrational mode frequency comprises introducing a first void of the one or more voids in the aerofoil, the first void having a centroid positioned at a first radial distance and a first circumferential distance, the first radial distance measured from the platform and the first circumferential distance measured from the leading edge, and
wherein the first radial distance of the centroid of the first void is between 15 percent and 40 percent of a height of the aerofoil measured along the first radial distance of the centroid of the first void and the first circumferential distance of the centroid of the first void is between 40 percent and 60 percent of a chord length of the aerofoil measured along the first circumferential distance of the centroid of the first void.

23. A method of manufacturing an aerofoil for a gas turbine, the method comprising:
designing the aerofoil for the gas turbine according to claim 11; and
forming the aerofoil according to the aerofoil so designed.

24. The method according to claim 23,
wherein forming the aerofoil comprises an additive manufacturing technique.
